(19) United States
(12) Patent Application Publication
(10) Pub. No.: US 2012/0006305 A1
(43) Pub. Date: Jan. 12, 2012

(54) Supercharging device for compressing charge air for an internal combustion engine

(75) Inventors: Hubert Hagel, Maselheim-Sulmingen (DE); Juergen Licht, Warthausen (DE); Stefan Coelsch, Gutenzell-Huerbel (DE); Joachim Nusser, Ertingen (DE); Andreas Lechleiter, Maselheim-Sulmingen (DE)

(73) Assignee: Handtmann Systemtechnik GmbH & Co. KG, Biberach/Riss (DE)

(21) Appl. No.: 13/067,871

(22) Filed: Jun. 30, 2011

(30) Foreign Application Priority Data
Jul. 2, 2010 (DE) DE 102010025984.5

(51) Int. Cl. F02B 33/36

(52) U.S. Cl. 123/559.3

(57) ABSTRACT

A supercharging device for compressing charge air for an internal combustion engine having a scroll compressor is proposed, a displacement scroll (5) being connected to the supercharger shaft by way of an eccentric arrangement between a front bearing and rear bearing of the supercharger shaft (6), an externally driven drive element, such as a belt pulley or the like, being provided outside a housing (1) of the supercharging device, and the supercharger shaft (6) being connectable to the externally driven drive element by means of a controllable clutch member.

The intended distinguishing features of the supercharging device according to the invention are a simpler bearing support and in particular a front bearing of smaller dimensions. This is achieved in that all connections of the drive and/or guide elements for the displacement scroll are arranged between the front bearing (2) and the rear bearing (3).

The invention relates to a supercharging device for compressing charge air for an internal combustion engine according to the preamble of claim 1.

Various supercharging devices for use on internal combustion engines have been disclosed, such as so-called turbochargers, which are driven by the exhaust gas flow from the engine. In addition there are supercharging devices which work on the displacement principle. Machines of the displacement type which have been disclosed also include devices which function with a scroll compressor. In such a compressor a displacement element is moved along a spiral housing. The displacement element is generally also of a spiral shape and is driven by an eccentric of a drive shaft. Supercharging devices with scroll compressors have been described, for example, in the publications DE 10 2007 043 579 A1, DE 10 2007 043-595 B4, DE 26 03 462 or EP 0 899 423 A1. A supercharging device having an oscillating crank bearing for the displacement scroll is furthermore described in DE 10 2009 017 201 A1.

Such supercharging devices, which work on the displacement principle, are generally mechanically coupled to a drive member of the internal combustion engine. Internal combustion engines are usually provided with a belt drive for auxiliary units, so that these are integrated into such a belt drive by means of a belt pulley. The belt drive exerts large lateral forces on the bearing shaft, so that its front bearing facing the belt pulley has to be of correspondingly large dimensions.

For flexible operation, supercharging devices that can be switched via magnetic clutches have also been disclosed by the publications EP 0 557 598 B1 and EP 0 545 189 B1. The supercharging devices described in this state of the art are provided with a further belt drive between the clutch and the front bearing of the supercharger shaft facing the clutch, in order to drive not only a first eccentric arrangement directly connected to the supercharger shaft but also a second eccentric arrangement for the displacement scroll. This additional belt drive again imposes lateral forces on the supercharger shaft, which have implications for the necessary dimensioning of the front bearing.

The object of the invention, therefore, is to develop a supercharging device so as to simplify the bearing support and in particular to reduce the dimensions of the front bearing.

Proceeding from a supercharging device according to the preamble of claim 1, this object is achieved by the characterizing features of that claim.

The measures specified in the dependent claims afford advantageous embodiments and developments of the invention.

According to the invention all connections of the drive elements and/or guide elements acting between the supercharger shaft and the displacement scroll are now arranged between the front bearing and the rear bearing.

In this way the part of the supercharger shaft pointing from the front bearing to the clutch or external drive element is freed of all lateral forces, which might be exerted by such drive and guide elements. This serves, according to the invention, to simplify the bearing support and in particular also the dimensioning of the front bearing.

The arrangement of all drive elements and guide elements of the displacement scroll cited above afford a supercharging device, in which no transfer gear elements for a force or torque split are provided between a carrier element fixed to the supercharger shaft and the bearing of the supercharger shaft pointing towards the carrier element. The free end of the supercharger shaft with carrier element in the form of a carrier disk, for example, is freely exposed virtually from the bearing of the supercharger shaft adjacent to the carrier element. The fact that no forces or torques of any kind of the supercharger shaft are split between the carrier element and said bearing means that the possible lateral forces cited above are avoided.

In a supercharging device according to the invention the displacement scroll is guided on its second eccentric arrangement by an oscillating crank, which through interaction with the first eccentric arrangement ensures the required movement of the displacement scroll. This type of oscillating crank used as a guide element affords positive guidance without any so-called dead points. For such a positive guidance of the displacement scroll it will suffice to drive this scroll via the supercharger shaft and the eccentric arrangement situated on it.

In a preferred embodiment the controllable clutch member is connected to the drive element by means of a clutch shaft. The drive element, which may be a conventional belt pulley, for example, connects this to the drive side of the clutch member via the clutch shaft.

Here the drive element is supported in a housing part of the supercharging device by means of a bearing independent of the supercharger shaft. This measure allows all forces that are transmitted to the supercharging device via the drive element, for example the belt pulley, to be dissipated directly into the housing of the supercharging device without acting on the supercharger shaft. This is particularly important particularly with regard to any lateral forces occurring. Since in conventional internal combustion engines the belt drive, by way of the belt pulleys, has to transmit a considerable torque to the auxiliary units and in particular also to a supercharging device according to the invention, such belt drives are subjected to a corresponding pre-tensioning and through this pre-tensioning generate considerable lateral forces.

The rotational speeds required of a supercharging device mean that the belt pulley, at least in the case of a direct coupling into the belt drive of the internal combustion engine, must not be of too large dimensions, although for transmitting torque to a belt pulley this results in small lever ratios, which have to be compensated for by greater pre-tensioning in the belt drive in order to increase the friction between the belt and the belt pulley. For design reasons, therefore, the lateral forces referred to above cannot be avoided.

If the drive element is supported directly in a housing part of the supercharging device, however, the lateral forces can be dissipated via the housing, so that the supercharger shaft, which drives the displacement element, is not adversely affected by such lateral forces. This in turn allows a more compact design of the bearings for the supercharger shaft provided inside the housing, so that a larger overall space is available for the requisite displacement volume.

The clutch shaft of the controllable clutch member is preferably also supported in a housing part independently of the supercharger shaft. The controllable clutch member, which is advantageously rotatably supported via the clutch shaft, may contain the substantial mass of the entire clutch. The bearing for the clutch shaft therefore has to be correspondingly designed and dimensioned. If this bearing is also supported directly on a housing part, the bearing support of the supercharger shaft will also remain unaffected by this measure. As a result the interior space of the supercharger housing can in turn be largely used to provide the corresponding displacement volume.

In a particularly advantageous embodiment a common bearing is provided for the clutch shaft, for the controllable clutch member and for the externally driven drive element. In this way it is possible, using one single, common correspondingly stable bearing, for all forces, both the lateral forces through the belt drive and the forces generated by the high-mass parts of the controllable clutch member and the clutch shaft, to be dissipated into the housing, without the bearing of the supercharger shaft and of the displacement element connected thereto being affected.

The housing part, which carries a bearing for the drive element and/or the clutch shaft, is advantageously designed as a separately mounted, flange-like component. This affords considerable advantages for the production and assembly of a supercharging device according to the invention. All forces occurring, which are applied to the flange-like housing part by the accordingly stable bearing by way of the drive element or the rotating parts of the controllable clutch member, can be dissipated to the housing of the supercharging device by way of corresponding bolted connections. In principle force-transmitting connections, for example dowels, pins or the like, can also be provided elsewhere between the housing and the flange-like housing part.

In a development of the invention the supercharger shaft is provided with at least one carrier disk, on which the controllable clutch member can act non-positively. In one particular embodiment the non-positive connection is achieved by way of frictional connection, that is to say the controllable clutch member comprises a disk, which is designed with a frictional face to complement the carrier disk and which in an axial direction of the supercharger shaft can be braced with the carrier disk of the supercharger shaft. Where necessary, one or more clutch plates may also be provided between them. The force may be transmitted between the controllable clutch member and the supercharger shaft in various ways according to known, conventional clutch mechanisms. In principle a non-positive connection via a positively interlocking coupling is also feasible, for example via a Hirth coupling or the like. It is advantageous, however, if the supercharging device can be selectively engaged with the drive element rotating, which in the case of a frictional connection is possible without the interposition of other torque converting elements.

As already mentioned above, in a supercharging device according to the invention the supercharger shaft may be supported separately from the clutch shaft and by and large from the clutch member. This bearing support is preferably undertaken inside the supercharger housing. Scroll-type superchargers are advantageously constructed so that they are substantially symmetrical about a plane of symmetry running transversely to the supercharger shaft. To this end scroll-type superchargers can be designed so that the scroll housing for producing the displacement volume is sub-divided by a partition wall lying in the plane of symmetry, a spiral displacement element being moveably arranged on both sides of this partition wall. This partition wall is provided with openings, so that both sides of the scroll-type supercharger are fed from a common air supply and discharge into a common outlet air line. This symmetrical construction of a scroll-type supercharger allows the supercharger shaft to be supported on both sides and in between allows an eccentric of the supercharger shaft to be centrally supported in the area of the partition wall.

If a supercharger according to the invention is now provided with a clutch member, which keeps the supercharger shaft itself free of all lateral forces and moreover also supports the greater proportion of the high-mass parts of the clutch elsewhere, the bearings of the supercharger shaft can also be kept compact using a controllable clutch and can furthermore be of identical design on both sides of the supercharger shaft.

Accordingly in an advantageous embodiment of the invention all components provided for actuating the clutch are arranged and supported on the controllable clutch member side, so that only one carrier element required for transmitting the force, for example a carrier disk, is provided on the supercharger shaft side. This carrier disk may be made from correspondingly lightweight material, for example magnesium, titanium, carbon or corresponding material.

One problem with a supercharging device for internal combustion engines is that this device is generally subjected to a speed even greater than that of the internal combustion engine. Speeds 2 to 3 times greater than the speed of the internal combustion engine are quite possible. The mechanism which has to ensure the smoothest possible running of the scroll-type supercharger is correspondingly elaborate. In order to cater for this mechanism and in particular also the balancing of masses, it is therefore basically advantageous to make all moving parts of such a supercharger of lightweight construction.

If according to the invention a corresponding supercharging device is then provided with a clutch, this lightweight construction and the fundamental construction of a conventional supercharger can be retained, if all components, which by virtue of the clutch construction entail a corresponding additional mass or which are subjected via the belt drive to corresponding lateral forces, are supported directly on the housing or on the housing part, without adversely affecting the supercharger shaft and hence the internal construction of the supercharger.

An exemplary embodiment of the invention is represented in the drawing and will be explained in more detail below with reference to the figure.

In particular:

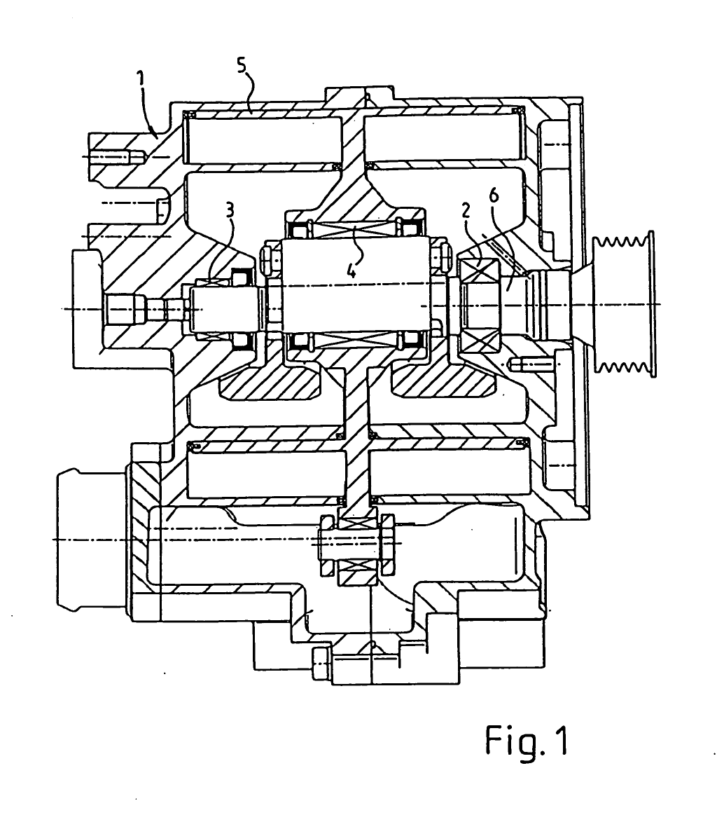

FIG. 1 shows a sectional representation of a scroll-type supercharger without a clutch according to the invention,

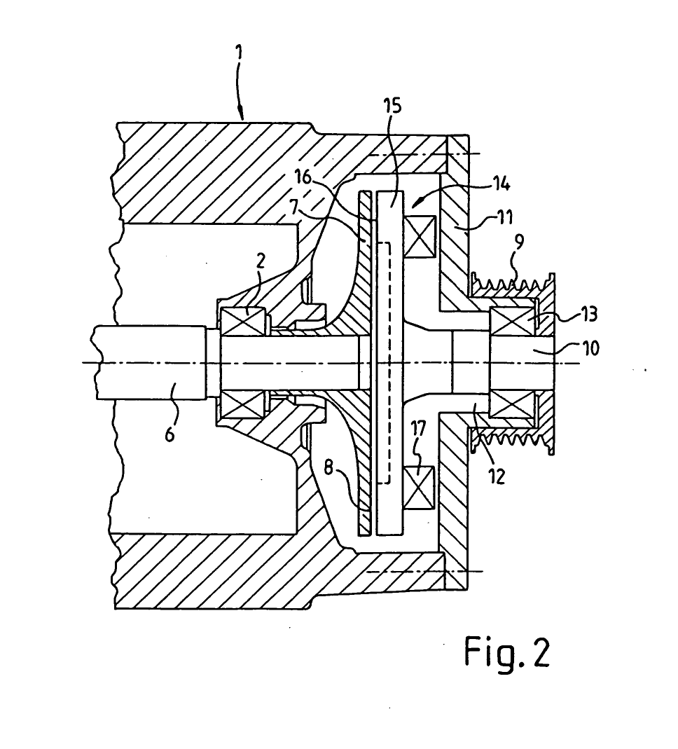

FIG. 2 shows a detail of a scroll-type supercharger with a clutch according to the invention, likewise in a sectional representation,

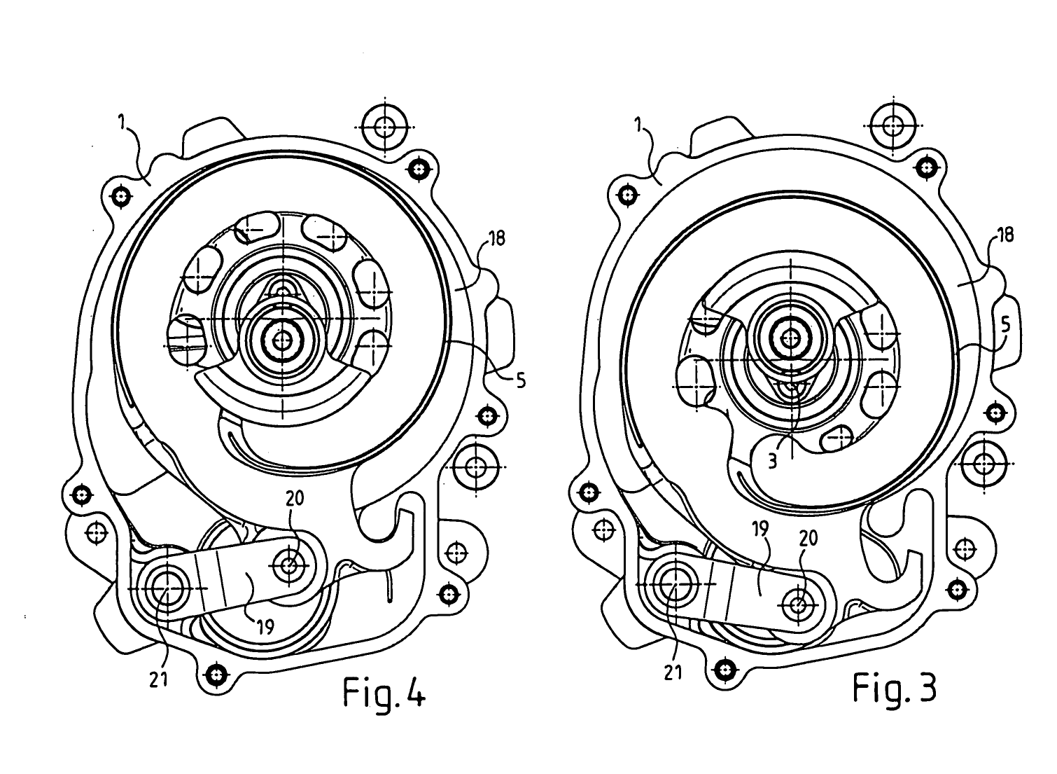

FIG. 3 shows a top view of an opened supercharging device in a first operating position and

FIG. 4 shows a top view according to FIG. 3 in a second operating position.

The supercharger housing 1 comprises two outer supercharger shaft bearings 2, 3 and an eccentric bearing 4, which is arranged between them and which serves for eccentrically guiding a displacement scroll 5, the drive being provided by way of the supercharger shaft 6.

In the embodiment according to FIG. 1 it can be seen that the supercharger shaft 6 carries a belt pulley 9. The supercharger shaft bearing 2 is therefore of significantly larger dimensions and is designed for considerably greater lateral forces than the opposing supercharger shaft bearing 3. The supercharger shaft bearing 2 takes up a correspondingly large overall space.

In the embodiment according to FIG. 2 with clutch according to the invention the supercharger shaft 6 is provided with a carrier disk 7, which has a friction face 8 in its outer area. Like all other moving parts of the supercharging device, the carrier disk 7 may also be of lightweight construction and in particular may also be produced from a light metal.

According to the invention the supercharger shaft 6 is now no longer driven directly by the belt pulley 9 in the belt drive of an internal combustion engine.

Instead, the drive is provided by mounting the belt pulley 9 on a clutch shaft 10, which is supported by way of a clutch bearing 13 in a housing flange 11 with a bearing fitting 12. The housing flange 11 can be firmly fixed to the housing 1 by bolted connections, not represented in further detail.

On the side of the housing flange 11 facing the supercharger housing 1, the clutch shaft 10 carries a controllable clutch member 14. The clutch member 14 comprises a clutch disk 15 having a friction lining 16. The friction lining 16 enables the clutch disk 15 to drive the carrier disk 7 with a corresponding frictional connection.

The frictional connection can be established in a manner not further represented, for example also through the interposition of one or more clutch plates. The clutch member is actuated by schematically represented actuating members 17. The actuating members of the clutch member 14 may be conventionally configured, for example.

The carrier disk 7 is preferably permanently braced with the clutch disk 15, for example by means of spring pressure, and is actively released by the actuating member. This can be achieved by a conventional construction, for example with the aid of a disk spring, not further represented. The clutch can then be disengaged by a corresponding, controllable actuating member, for example a solenoid, a servomotor or the like, it being possible to open the clutch through corresponding counter-pressure to the biased spring.

An inverse construction is obviously also feasible, in which the clutch is actively closed and passively opened.

The actual design of the clutch and its actuating members is of subordinate importance in the present invention. Rather what is important is that the major part of the high-mass clutch members and also the belt pulley 9 be supported separately from the supercharger shaft 6, as is the case in the exemplary embodiment shown, where it is supported via the clutch bearing 13. This clutch bearing 13 can be of robust dimensions and can be designed so that not only is the substantial mass of the clutch supported but the lateral forces applied by the belt drive are at the same time dissipated into the supercharger housing 1.

It can clearly be seen in the exemplary embodiment represented that the free end of the supercharger shaft, which supports the carrier disk 7, does not have any transmission elements of any kind between the carrier disk 7 and the bearing 2 facing the carrier disk 7, for distributing the torque transmitted by the carrier disk.

It can be seen from FIGS. 3 and 4 that the charge air volume 18 is moved as closed, lunate chambers in the rotation of the supercharging device, thereby delivering and compressing the charge air.

The displacement scroll 5 is supported at the outer end in an oscillating crank 19. The bearing axis 20 of the displacement scroll 5 is forced into a periodically oscillating movement on a circular segment through the positive guidance by the oscillating crank 19. The oscillating crank 19 is rotatably supported in the oscillating crank axis 21 in the housing 1.

This oscillating bearing support of the displacement scroll 6 with the oscillating crank 19 produces a positive guidance of the displacement scroll 5 without dead points. The displacement scroll 5 is driven solely via the supercharger shaft 6. All drive and guide elements for the displacement scroll are arranged between the front bearing 2 and the rear bearing 3.

On the side facing the clutch the supercharger shaft supports only the carrier disk 7 for transmitting torque. This disk is stressed only in an axial direction, however, and does not transmit lateral forces of any kind.

This allows a correspondingly simpler, more compact and identical configuration of the supercharger shaft bearings 2, 3. This affords a larger space for the displacement volume.

Arranging the clutch bearing in a housing flange according to the exemplary embodiment shown moreover facilitates assembly of the supercharger clutch and affords good access in the case of repair and servicing.

### LIST OF REFERENCE NUMERALS

1 supercharger housing
2 supercharger shaft bearing
3 supercharger shaft bearing
4 eccentric bearing
5 displacement scroll
6 supercharger shaft
7 carrier disk
8 friction face
9 belt pulley
10 clutch shaft
11 housing flange
12 bearing fitting
13 clutch bearing
14 clutch member
15 clutch disk
16 friction lining
17 actuating member
18 charge air volume
19 oscillating crank
20 bearing axis
21 oscillating crank axis

What is claimed is:

1. A supercharging device for compressing charge air for an internal combustion engine having a scroll compressor, a displacement scroll (5) being connected to the supercharger shaft by way of an eccentric arrangement between a front bearing and rear bearing of the supercharger shaft (6), an externally driven drive element (9), such as a belt pulley or the like, being provided outside a housing (1) of the supercharging device, and the supercharger shaft (6) being connectable to the externally driven drive element (9) by means of a controllable clutch member (14), wherein all connections of the drive and/or guide elements acting between the supercharger shaft (6) and the displacement scroll (5) are arranged with the supercharger shaft between the front bearing (2) and the rear bearing (3).

2. A supercharging device for compressing charge air for an internal combustion engine having a scroll compressor, a displacement scroll (5) being connected to the supercharger shaft (6) by way of an eccentric arrangement between a front bearing (2) and a rear bearing (3) of the supercharger shaft (6), an externally driven drive element (9), such as a belt pulley or the like, being provided outside a housing (1) of the supercharging device, and the supercharger shaft (6) being connectable to the externally driven drive element (9) by means of a controllable clutch member (14) by way of a carrier element (7) of the clutch member (14) fixed to the supercharger shaft (6), wherein no force or torque distribution is provided between the carrier element (7) of the clutch member (14), fixed to the supercharger shaft (6), and the supercharger shaft bearing (2) facing the carrier element (7).

3. The supercharging device as claimed in claim 1 or 2, wherein at one end the displacement scroll is supported and guided via a mechanical oscillating crank.

4. The supercharging device as claimed in one of the aforesaid claims, wherein the drive element (9) is supported in a housing part (11) by means of a bearing (13) independent of the supercharger shaft (6).

5. The supercharging device as claimed in one of the aforesaid claims, wherein forces, in particular lateral forces, acting on the drive element (9), can be dissipated to the supercharger housing (1) via the bearing (13) of the drive element (9).

6. The device as claimed in one of the aforesaid claims, wherein a common bearing (13) is provided for the drive element (9) and a clutch shaft (10).

7. The device as claimed in one of the aforesaid claims, wherein the drive element (9) is rotationally fixed to the clutch shaft (10) and is supported by way of the clutch shaft (10).

8. The device as claimed in one of the aforesaid claims, wherein a separately mountable housing part (11) is provided with the bearing (13) for the drive element (9) and/or the clutch shaft (10).

9. The device as claimed in one of the aforesaid claims, wherein the supercharger shaft (6) comprises at least one carrier disk (7), which together with the controllable clutch member (14) forms a clutch.

10. The device as claimed in one of the aforesaid claims, wherein the supercharger shaft (6) is supported in the supercharger housing (1) separately from the clutch shaft (10) and the clutch member (14).

11. The device as claimed in one of the aforesaid claims, wherein all components provided for actuation of the clutch are arranged and supported on the controllable clutch member (14) side.

12. An internal combustion engine having a charge air compressor, wherein a device according to one of the aforesaid claims is provided.
